(19) United States
(12) Patent Application Publication
(10) Pub. No.: US 2008/0164695 A1
(43) Pub. Date: Jul. 10, 2008

(54) Ferrules Manufactured From Hollow Stock

(76) Inventors: Gerhard H. Schiroky, Aurora, OH (US); Peter C. Williams, Cleveland Heights, OH (US); Michael W. Jones, Houston, TX (US)

Correspondence Address: CALFEE HALTER & GRISWOLD, LLP, 800 SUPERIOR AVENUE, SUITE 1400, CLEVELAND, OH, 44114, US

(21) Appl. No.: 11/884,094

(22) PCT Filed: Feb. 13, 2006
(86) PCT No.: PCT/US06/04834

§ 371 Date: Aug. 9, 2007

Related U.S. Application Data
(60) Provisional application No. 60/652,617, filed on Feb. 14, 2005.

(51) Int. Cl. F16L 19/08; B23Q 17/00

(52) U.S. Cl. 285/342; 29/406

(57) ABSTRACT

The present invention relates to ferrules for use in fittings of the type that are used for gripping a body, such as a tube end. More particularly, the invention provides ferrules manufactured from hollow stock, such as welded hollow stock and processes for making such ferrules.

### RELATED APPLICATION

This application claims the benefit of U.S. Provisional Application No. 60/652,617, filed Feb. 14, 2005, the entire disclosure of which is incorporated by reference.

### FIELD OF THE INVENTION

The present invention relates to fittings of the type that use one or more ferrules for gripping a tube end. More particularly, the invention provides ferrules manufactured from hollow stock and processes for making such ferrules. By “hollow stock” is meant the fundamental raw material prior to machining a ferrule, whether there are additional refinement steps or not prior to or after machining of the ferrule. The invention is applicable to various types of ferrules including, but not limited to, ferrules used in gripping-style fittings and ferrules used in bite-style fittings.

### BACKGROUND OF THE INVENTION

In this application, the term tube broadly refers to any tube, pipe or conduit. A two ferrule tube fitting that has been highly successful for over 30 years is a sequential gripping arrangement invented by Lennon, et al., U.S. Pat. No. 3,103,373, the entire disclosure of which is fully incorporated herein by reference.

In a typical ferrule-type tube fitting assembly there is a coupling arrangement that includes a coupling body and a coupling nut. The coupling body includes an axially tapered opening or camming mouth and a shoulder or stop axially spaced from the tapered opening. Front and rear ferrules are positioned within the coupling nut and are interposed between the coupling body and the coupling nut. A tube end is axially inserted into the fitting until the tube end abuts the inner shoulder stop of the coupling body. Rotation of the nut with respect to the coupling body drives the coupling components axially towards each other to pull the ferrules axially together, and radially displace the ferrules inwardly to grip the tube.

In the past, ferrules have been machined from a solid piece of bar stock. Ferrules machined from solid stock have proven to be extremely reliable

### SUMMARY

The present invention relates to fittings of the type that use one or more ferrules for gripping a tube end. More particularly, the invention provides ferrules manufactured from hollow stock and processes for making such ferrules. Thus, in one aspect, the invention relates to a ferrule comprising an annular body with a longitudinal central axis and including a longitudinal weld seam.

In another aspect, the invention relates to a method of manufacturing a ferrule, comprising the steps of rolling a sheet of metal to position a first edge of the sheet adjacent to a second edge of the sheet; welding the first edge of the sheet to the second edge of the sheet to create a welded hollow stock with a longitudinal weld seam; and forming a ferrule from the welded hollow stock.

In another aspect, the invention relates to a method of making a ferrule, comprising the steps of forming a length of seamless hollow stock, and forming a ferrule from the seamless hollow stock.

### BRIEF DESCRIPTION OF THE DRAWINGS

Further aspects, advantages and benefits will become apparent to those skilled in the art after considering the following description and appended claims in conjunction with the accompanying drawings, in which:

FIG. 1 is a side elevational view of a tube fitting ferrule made from hollow stock;

FIG. 2 is a perspective view of a tube fitting ferrule made from hollow stock;

FIG. 3 is a side elevational view of a tube fitting ferrule made from hollow stock;

FIG. 4 is a perspective view of a tube fitting ferrule made from hollow stock;

FIG. 5 is an illustration of a tube secured in a tube fitting shown in partial longitudinal cross-section;

FIG. 6 is a schematic illustration of a sheet of ferrule stock material;

FIG. 7 is a schematic illustration of the ferrule stock material rolled to form a tube;

FIG. 8 is a schematic illustration of the ferrule stock tube with a welded seam;

FIGS. 9A and 9B schematically illustrate manufacturing of seamless ferrule stock tube;

FIG. 10 is a schematic illustration of a seamless ferrule stock tube;

FIG. 11 schematically illustrates machining a ferrule stock tube to form a ferrule; and

FIG. 12 schematically illustrates machining a ferrule stock tube to form a ferrule.

### DETAILED DESCRIPTION

The present invention provides ferrules manufactured from hollow stock. Examples of hollow stock include welded stock 12 (FIG. 8) and seamless stock 16 (FIG. 10). The invention also provides processes for making such ferrules.

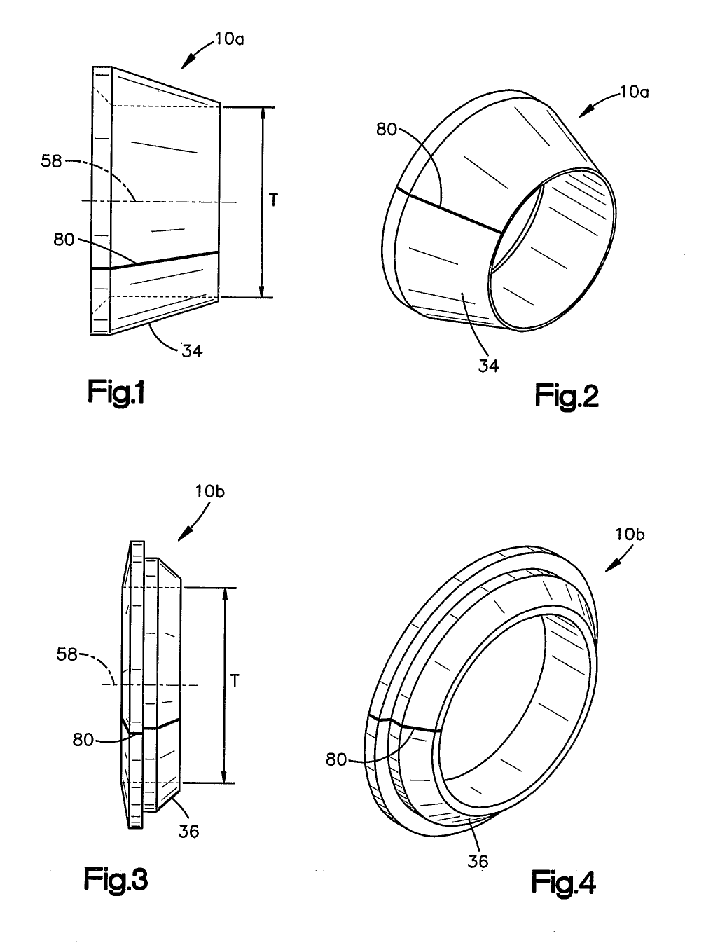

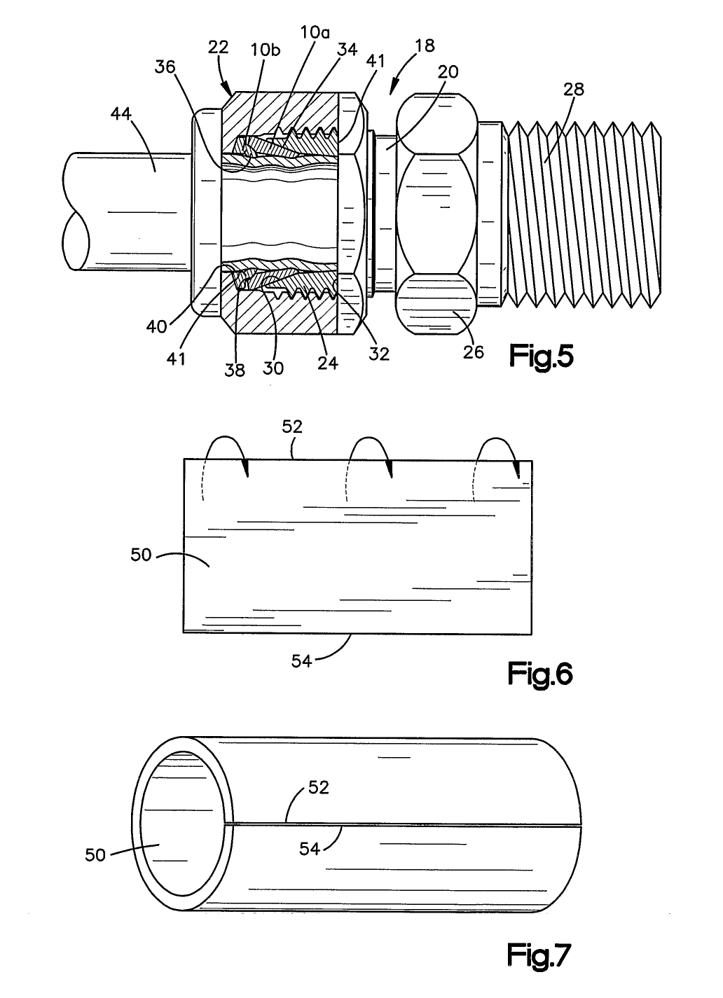

FIGS. 1-4 illustrate examples of finished ferrules in accordance with the present invention, specifically, tube fitting ferrules 10a, 10b. FIGS. 1 and 2 illustrate an example of a front tube fitting ferrule 10a (described below in detail). FIGS. 3 and 4 illustrate an example of a rear tube fitting ferrule 10b (described below in detail). The ferrules (described below in detail) that are illustrated in FIGS. 1-4 may be used, for example, in a fitting such as the male tube fitting 18 illustrated in FIG. 5 which shows ferrules 10a and 10b of the present invention.

The specific, exemplary tube fitting 18 illustrated in FIG. 5, as an environment for ferrules of the present invention, includes a coupling body 20 and a coupling nut 22 that may be threadably engaged with threads 24 on one end of the coupling body. The tube fitting ferrules may also be used in a non-threaded coupling. The coupling body 20 may include a torquing flange, for example in the form of a hex shaped flange 26. The coupling body 20 may also include a second threaded end 28 that allows the coupling body 20 be joined to another body, conduit or device; such as a flow control device. The coupling body 20 includes an axially tapered opening or camming mouth 30 and a shoulder or stop 32 that, in the illustrated embodiment, is axially spaced from the tapered opening. Two tube fitting ferrules 10a, 10b are interposed between the coupling body 20 and the coupling nut 22.

During assembly, a tapered front end 34 of the front ferrule 10a initially engages the camming mouth 30 of the coupling body 20. A tapered front end 36 of the rear ferrule 10b initially engages a camming surface 38 at the back end of the front ferrule. The coupling nut 22 has a shoulder 40 that drivingly engages a back wall surface 41 of the rear ferrule. The back wall surface 41 of the rear ferrule is an included portion of the outer surface of the ferrule that is configured for engagement with a fitting nut, such as the nut 22. A tube end 44 is axially inserted into the fitting until the tube end abuts the inner shoulder stop 32 of the coupling body 20. Relative rotation of the coupling body 20 and the nut 22 drives the coupling components axially towards each other. As the coupling components move toward one another, the ferrules 10a, 10b are axially pulled together, and are radially displaced inwardly to cause a sequential inward gripping of the tube 44. The ferrules 10a, 10b tightly grip the wall of the tube end 44 because of this swaging action. Other assembly techniques are available for fittings using ferrules of the present invention, including pre-installing ferrules on the tube end.

Ferrules in accordance with the present invention can also be used in a single ferrule coupling, for example. Fittings that use ferrules are commonly used in sophisticated chemical processing apparatus because of their high reliability. For example, in the semiconductor industry, such fittings assure containment of expensive or toxic chemicals. Typically, these applications are high purity and therefore, rely on conduits made of stainless steel or other low corrosion, high strength alloys. Ferrule fittings can also be used in the automotive industry, for example, in the area of alternative fuels such as high pressure hydrogen. Those skilled in the art will readily appreciate that any one or more of the aspects and features of the invention may be used with materials other than stainless steel and can be used with many conduits including, but not limited to, tube or pipe. Still further, the exemplary embodiments herein illustrate what is commonly known as a male-style fitting, meaning that a male (i.e. externally threaded) component receives and abuts the conduit end. Many aspects of the invention will find application in female-style fittings as will be apparent to those skilled in the art. The invention will also find application for fitting assemblies that do not require threaded connections between the fitting components, for example clamped or bolted fittings may be used. The invention will also find application far beyond the exemplary embodiments herein as to connections that can be made to a wide and ever expansive variety of fluid components including, but not limited to, other conduits, flow control devices, containers, manifolds and so on.

However, machining ferrules from solid stock can waste much of the raw material. In accordance with the present invention, ferrules are made from hollow stock, rather than solid stock. One example of hollow stock is welded hollow stock. Various processes are known for making welded hollow stock. FIGS. 6-8 illustrate schematically one known method, or process, of forming welded hollow stock 12. FIG. 6 illustrates a flat sheet 50 of material, such as stainless steel. One exemplary material is SS 316L strip. The sheet 50 (FIGS. 6 and 7) is rolled to position a first edge 52 of the sheet adjacent to a second edge 54 of the sheet. The first edge 52 (FIG. 8) of the sheet 50 is welded to the second edge 54 of the sheet to form the welded hollow stock 12. In one embodiment, the first edge 52 is welded directly to the second edge 54. In another embodiment, the first edge 52 is connected to the second edge 54 by a welding process in which a filler material fills a gap between the first and second edges. One exemplary welding method involves gas tungsten arc welding.

The welding process provides a longitudinal weld seam 56 on the stock 12, that extends parallel to a longitudinal central axis 58 of the stock. In accordance with the present invention, welded hollow stock may be further processed to improve the quality of the stock, prior to forming a ferrule from the stock. The goal is to transform a welded strip into a hollow stock that has the dimensions and properties required for making a ferrule. (When a solid bar stock is used to make a ferrule, the stock as provided has the required material characteristics. The bar is machined both to provide the required overall dimensions (such as OD and ID) and to provide the specific dimensions and configuration of the ferrule.)

For example, in accordance with the present invention, the welded hollow stock may be annealed and/or drawn once or several times. In an exemplary method, the welded hollow stock is annealed, which dissolves ferrite in the weld zone and relieves any stresses that may have resulted from welding. Next, the stock may be cold drawn, which controls desired dimensions (such as outside diameter, inside diameter, wall thickness, and concentricity) and which also may deform the grains in the material. Next, the stock may be annealed again, which recrystallizes the material in order to end up with a uniform microstructure throughout the tube. Then, the stock may be cold drawn again, which obtains final dimensions and obtain the desired mechanical properties. For example, the cold drawing may be used to strain harden the material, i.e., impart a higher yield strength. Other such processes may be suitable and may be used. It should be noted, however, that for some ferrule designs the welded hollow stock may be suitable as is with little or no additional processing of the stock material.

The processing of the welded stock may, for example, effectively make the weld seam 56 indistinguishable from the balance of the welded stock. That is, the weld is homogenized. Although the weld seam is still present, it is visually indistinguishable. Also, the resulting welded hollow stock is not weaker or inconsistent in any structural property at the location of the weld seam. In addition, the resulting stock has the needed ferrule properties, such as minimum tensile strength, minimum yield strength, and elongation. Several pieces of welded stock for ferrules made in accordance with the invention had the following properties.

| | | Yield | Tensile | | |
|---|---|---|---|---|---|
| | | Strength | Strength | Elongation (2 in. | Hardness |
| OD (in.) | ID (in.) | (psi) | (psi) | section) | (HRC) |
| 0.504 | 0.370 | 104,900 | 120,700 | 21% | 22-23 |
| 0.629 | 0.495 | 98,30 | 114,000 | 22% | 20-21 |
| 0.6915 | 0.495 | 92,200 | 114,800 | 21% | 20-21 |

One advantageous feature of welded hollow stock is that it has a uniform wall thickness, arising from the fact that it is made from very flat strip as a starting material. The uniform wall thickness is helpful in making an acceptable ferrule. Another advantageous feature of welded stock is that there is less waste of raw material, as compared to, for example, drilling then machining a solid bar stock.

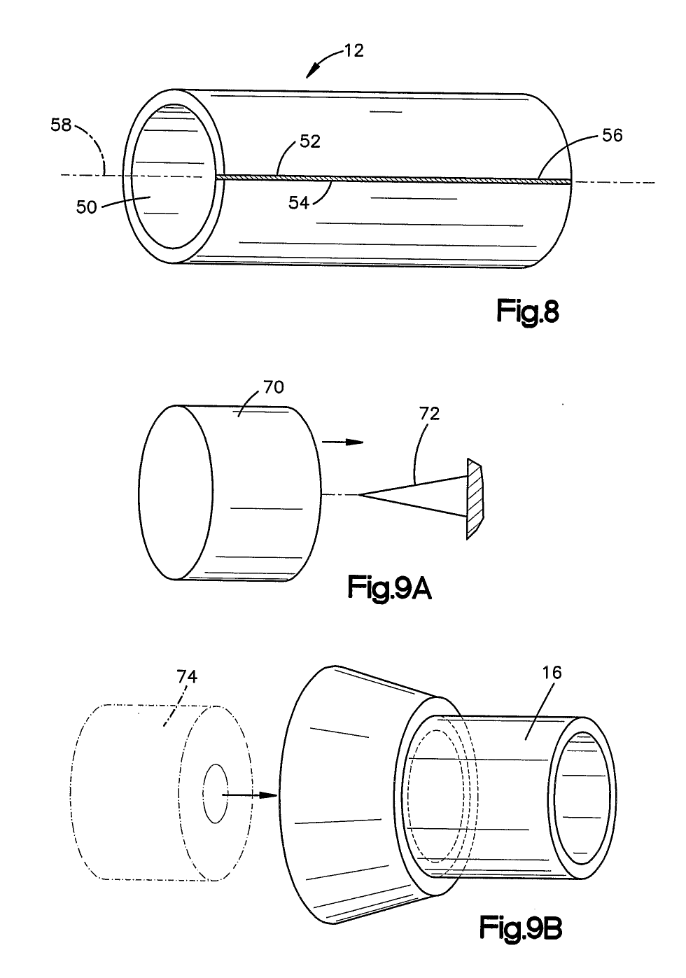

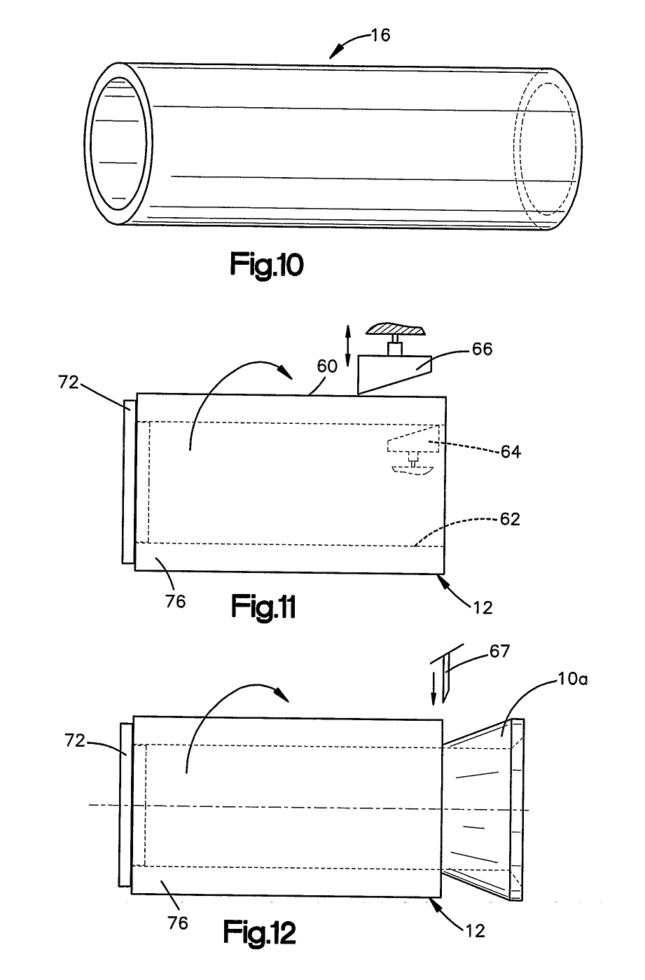

In accordance with the invention, ferrules may also be provided that are made from seamless hollow stock, as an alternative to the welded hollow stock discussed above. FIGS. 9A, 9B and 10 illustrate schematically one known method of forming a length of seamless hollow stock 16, specifically, extrusion. Another known method (not illustrated) involves the use of hollow bar. In the extrusion process, a raw material 70 (FIGS. 9A and 9B) for the stock is forced against a member 72 to form a seamless shell 74. In FIG. 9B, the shell 74 is heated and further extruded to form the seamless hollow stock 16. The seamless hollow stock 16 may be further processed to improve the quality of the stock. For example, the stock 16 may be annealed and or drawn, once or multiple times.

The illustrated seamless stock 16 and welded stock 12 may be made from a variety of different materials. Specifically, those skilled in the art will readily appreciate that the invention may be realized using any number of different types of metals for ferrules, including but not limited to 316, 316L, 304, 304L, any austenitic or ferritic stainless steel, any duplex stainless steel, any nickel alloy such as HASTALLOY, INCONEL, MONEL, alloy 825, alloy 625, any precipitation hardened stainless steel such as 17-4PH for example, brass, copper alloys, any carbon or low allow steel such as 12L14 steel for example. The material for the ferrules may be selected from the stainless steel materials noted above, or other suitable materials, such as magnesium, titanium and aluminum, to name some additional examples.

Still further, ferrules of the present invention may be case hardened, for example by a low temperature carburization process to provide very hard ferrules that are corrosion resistant. The case hardening may be applied over a portion or all of the ferrule surface. A number of issued patents disclose such case hardening and geometry concepts that may be applied to the ferrules, such as U.S. Pat. Nos. 6,629,708; 6,547,888; 6,165,597; and 6,093,303 issued to the assignee of the present invention, the entire disclosures of which are fully incorporated herein by reference, as well as PCT International Publication Nos. WO 02/063195A2 and WO 02/063194A3 also incorporated herein by reference. Such patents and the concepts therein are exemplary in nature as to the present invention and should not be construed in a limiting sense. Many different case hardening processes and a wide variety of geometric configurations may be used to properly control the plastic deformation of the ferrules during pull-up to assure adequate seal and tube grip.

FIGS. 11 and 12 illustrate schematically one exemplary method of working the hollow stock 12 to form ferrules of the present invention; other methods may be used. The hollow stock 12 is typically provided in a relatively long piece, for example, up to twenty feet in length. In the example provided by FIGS. 11 and 12, material is removed from an end portion of the piece of stock 12 to form the ferrule 10a illustrated by FIGS. 1 and 2. The material is removed by rotating the length of stock 12 and applying an inner tool 64 and/or an outer tool 66, to remove material from an inner surface 62 and/or an outer surface 60 of the stock, to define the ferrule shape. A severing tool 67 (FIG. 12) is applied to sever the formed ferrule 10a from the length of stock 12. This process is repeated to form multiple ferrules from the length of stock 12.

Optionally, a machine lubricant and/or a cooling oil is applied to the tools 64, 66, 67 and the tube 12. In the embodiment illustrated by FIGS. 11 and 12, a plug 72 is disposed in one or more of the ends 76 of the tube 12. The plug(s) prevent the lubricant from running out the end(s) of the tube.

Ferrules having a variety of different profiles may be formed by various methods including the method illustrated by FIGS. 11 and 12. For example, the ferrule illustrated by FIGS. 3 and 4 may be made from hollow stock using the method illustrated by FIGS. 11 and 12. When welded hollow stock is used, the ferrules include a longitudinal weld seam. When seamless tube is used, the ferrules do not include a longitudinal weld seam.

It should be understood that the forming processes described and illustrated are represented only schematically. Typically, in production, raw material in the form of strip is cold-formed into a tubular shape using a series of rollers. Because the strip is long, forming and subsequent welding can be considered continuous processes that can enhance the economic feasibility of this process.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1-21. (canceled)

22. A tube fitting comprising:
a female fitting component;
a male fitting component received by the female fitting component;
a ferrule interposed between the male fitting component and the female fitting component;
wherein the ferrule is configured to grip a tube upon axial movement of the male and female fitting components toward one another;
wherein the ferrule comprises an annular body with a longitudinal central axis and a longitudinal weld seam.

23. The tube fitting of claim 22 wherein the weld seam is defined by a homogenized weld.

24. The tube fitting of claim 23 wherein the weld seam is homogenized by multiple annealing steps and drawing steps.

25. The tube fitting of claim 22 wherein the ferrule includes a contoured outer surface that is configured for engagement with at least one of the male and female fitting components, and an inner surface that is configured for engagement with the tube.

26. The tube fitting of claim 25 wherein the contoured outer surface is configured for engagement with a camming mouth of one of the male and female fitting components to cause the ferrule to grip the tube.

27. The tube fitting of claim 22 wherein the ferrule is made from welded stock that is annealed and cold drawn after the weld seam is formed.

28. The tube fitting of claim 22 wherein the ferrule is made from welded stock that is annealed and cold drawn twice after the weld seam is formed.

29. The tube fitting of claim 22 wherein the ferrule is case hardened.

30. The tube fitting of claim 22 wherein the ferrule seals with at least one of the male fitting component and the female fitting component.

31. A ferrule for a tube fitting comprising:
an annular body that is contoured to grip a tube, the annular body including a longitudinal central axis and a longitudinal weld seam.

32. The ferrule of claim 31 wherein the weld seam is formed by a homogenized weld.

33. The ferrule of claim 32 wherein the weld is homogenized by multiple annealing steps and multiple drawing steps.

34. The ferrule of claim 31 wherein an outer surface of the annular body is contoured for engagement with a fitting member, and an inner surface of the annular body is contoured for engagement with a tube.

35. The ferrule of claim 34 wherein the outer surface is configured for engagement with a coupling body and wherein the annular body includes an end surface that is configured for engagement with a fitting nut.

36. The ferrule of claim 34 wherein the contoured outer surface is configured for engagement with a camming mouth of the fitting component to cause the inner surface of the ferrule to grip the tube.

37. The ferrule of claim 31 wherein the annular body is made from welded stock that is annealed and cold drawn after the weld seam is formed.

38. The ferrule of claim 31 wherein the annular body is made from welded stock that is annealed and cold drawn twice after the weld seam is formed.

39. The ferrule of claim 31 wherein the ferrule is case hardened.

40. A method of manufacturing a ferrule, comprising the steps of:
forming a length of welded hollow stock with a longitudinal weld seam; and
contouring the hollow stock to form a ferrule that is configured to grip and seal a tube.

41. The method of claim 40 wherein the ferrule is configured to seal against a fitting component.

42. The method of claim 40 the step of forming a welded hollow stock comprises forming a length of welded hollow stock that is longer than the ferrule to be made, and the method further comprises cutting off a contoured ferrule from the length of welded hollow stock.

43. The method of claim 40 further comprising annealing and drawing the welded hollow stock prior to contouring the hollow stock to form the ferrule.

44. The method of claim 40 wherein the welded hollow stock is annealed and drawn twice prior to forming the ferrule.

45. The method of claim 40 wherein the hollow stock welded stock is contoured by removing material from an outer surface and from an inner surface of the welded hollow stock and wherein a the welded hollow stock is severed to form the ferrule.

46. A method of making a ferrule, comprising the steps of:
forming a length of seamless hollow stock; and
forming a ferrule from the seamless hollow stock.

47. The method of claim 46 wherein forming a length of seamless hollow stock comprises forming a length of seamless hollow stock that is longer than the ferrule to be made, and wherein the method further comprises of cutting off the formed ferrule from the length of seamless hollow stock.

48. The method of claim 46 wherein forming a length of seamless hollow stock comprises extruding the seamless hollow stock.

49. The method of claim 46 wherein forming the ferrule comprises removing material from an outer surface and from an inner surface of the seamless hollow stock and severing the stock.

50. The method of claim 46 further comprising annealing and drawing the seamless hollow stock prior to forming the ferrule.

51. The method of claim 46 further comprising case hardening the ferrule.
